(19) United States
(12) Patent Application Publication
(10) Pub. No.: US 2014/0285519 A1
(43) Pub. Date: Sep. 25, 2014

(54) METHOD AND APPARATUS FOR PROVIDING LOCAL SYNCHRONIZATION OF INFORMATION FOR AUGMENTED REALITY OBJECTS

(71) Applicant: NOKIA CORPORATION, Espoo (FI)

(72) Inventors: Mikko Aleksi Uusitalo, Helsinki (FI); Sergey Boldyrev, Soderkulla (FI); Jari-Jukka Harald Kaaja, Jarvenpaa (FI); David Joseph Murphy, Helsinki (FI)

(73) Assignee: Nokia Corporation, Espoo (FI)

(21) Appl. No.: 13/849,208

(22) Filed: Mar. 22, 2013

(51) Int. Cl. G06T 19/00

(52) U.S. Cl. CPC G06T 19/006
USPC 345/633

(57) ABSTRACT

An approach is provided for local synchronization of information for augmented reality objects. A mixed reality platform determines at least one augmented reality object of at least one augmented reality information space associated with at least one device. The mixed reality platform determines local information associated with the at least one device, one or more other devices proximate to the at least one device, or a combination based, at least in part, on a relevancy of the local information to the at least one augmented reality object. The mixed reality platform then causes, at least in part, a presentation of the local information as one or more layers of an augmented reality user interface depicting the at least one augmented reality object.

### BACKGROUND

Service providers and device manufacturers (e.g., wireless, cellular, etc.) are continually challenged to deliver value and convenience to consumers by, for example, providing compelling network services. One area of interest has been the development of location-based services (e.g., navigation services, mapping services, augmented reality applications, etc.) that have greatly increased in popularity, functionality, and content. Augmented reality and mixed reality applications allow users to see a view of the physical world merged with virtual objects (e.g., augmented reality objects) in real time. Mapping applications further allow such augmented reality objects to be annotated with location information and other user information. Historically, these objects and their annotated information are stored in a centrally stored database (e.g., a network store). However, in some cases, the augmented reality objects and/or associated annotated information may include local information (e.g., information store on user devices rather than network stores) that is not amenable to central storage and delivery (e.g., when data changes quickly, data has only local relevance, data is sensitive, etc.). Accordingly, service providers and device manufacturers face significant technical challenges to integrating locally stored information (e.g., information) with networked served augmented reality information (e.g., map tiles, augmented reality tiles, etc.), particularly when the local information are stored across multiple local devices.

### SOME EXAMPLE EMBODIMENTS

Therefore, there is a need for an approach for providing local synchronization of information for augmented reality objects.

According to one embodiment, a method comprises determining at least one augmented reality object of at least one augmented reality information space. The method also comprises determining local information from at least one device, one or more other devices proximate to the at least one device, or a combination based, at least in part, on a relevancy of the local information to the at least one augmented reality object. The method further comprises causing, at least in part, a presentation of the local information as one or more layers of an augmented reality user interface depicting the at least one augmented reality object

According to another embodiment, an apparatus comprises at least one processor, and at least one memory including computer program code for one or more computer programs, the at least one memory and the computer program code configured to, with the at least one processor, cause, at least in part, the apparatus to determine at least one augmented reality object of at least one augmented reality information space. The apparatus is also caused to determine local information from at least one device, one or more other devices proximate to the at least one device, or a combination based, at least in part, on a relevancy of the local information to the at least one augmented reality object. The apparatus further causes, least in part, a presentation of the local information as one or more layers of an augmented reality user interface depicting the at least one augmented reality object.

According to another embodiment, a computer-readable storage medium carries one or more sequences of one or more instructions which, when executed by one or more processors, cause, at least in part, an apparatus to determine at least one augmented reality object of at least one augmented reality information space. The apparatus is also caused to determine local information from at least one device, one or more other devices proximate to the at least one device, or a combination based, at least in part, on a relevancy of the local information to the at least one augmented reality object. The apparatus further causes, least in part, a presentation of the local information as one or more layers of an augmented reality user interface depicting the at least one augmented reality object.

According to another embodiment, an apparatus comprises means for determining at least one augmented reality object of at least one augmented reality information space. The apparatus also comprises means for determining local information from at least one device, one or more other devices proximate to the at least one device, or a combination based, at least in part, on a relevancy of the local information to the at least one augmented reality object. The apparatus further comprises means for causing, at least in part, a presentation of the local information as one or more layers of an augmented reality user interface depicting the at least one augmented reality object.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing local synchronization of information for augmented reality objects, according to one embodiment;

FIG. 2 is a diagram of the components of an mixed reality platform, according to one embodiment;

FIG. 3 is flowchart of a process for providing local synchronization of information for augmented reality objects, according to one embodiment;

FIG. 4 is a diagram illustrating synchronization of local information associated with an augmented reality view, according to one embodiment;

FIG. 5 is a diagram illustrating information to be shared between layers of an augmented reality overlay, according to one embodiment;

FIG. 6 is a diagram illustrating rendering of different augmented reality views for different devices, according to one embodiment;

FIG. 7 is a diagram illustrating synchronization of local primitives through composition and decomposition, according to one embodiment;

FIGS. 8A and 8B is a diagram illustrating synchronization of local information via a launch pad for a single user, according to one embodiment;

FIG. 9 is diagram illustrating synchronization of location information via launch pads of multiple users, according to one embodiment;

FIGS. 10A-10B are flowcharts of a process for processing augmented reality objects in an augmented reality environment, according to one embodiment;

FIGS. 11A-11C are diagrams of user interfaces utilized in the processes of FIGS. 1-12B, according to various embodiments;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for providing local synchronization of information for augmented reality objects are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “computation closure” identifies a particular computation procedure together with relations and communications among various processes including passing arguments, sharing process results, selecting results provided from computation of alternative inputs, flow of data and process results, etc. The computation closures (e.g., a granular reflective set of instructions, data, and/or related execution context or state) provide the capability of slicing of computations for processes and transmitting the computation slices between devices, infrastructures and information sources.

As used herein, the term “cloud” refers to an aggregated set of information and computation closures from different sources. This multi-sourcing is very flexible since it accounts and relies on the observation that the same piece of information or computation can come from different sources. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats. Although various embodiments are described with respect to clouds, it is contemplated that the approach described herein may be used with other structures and conceptual description methods used to create distributed models of information and computations.

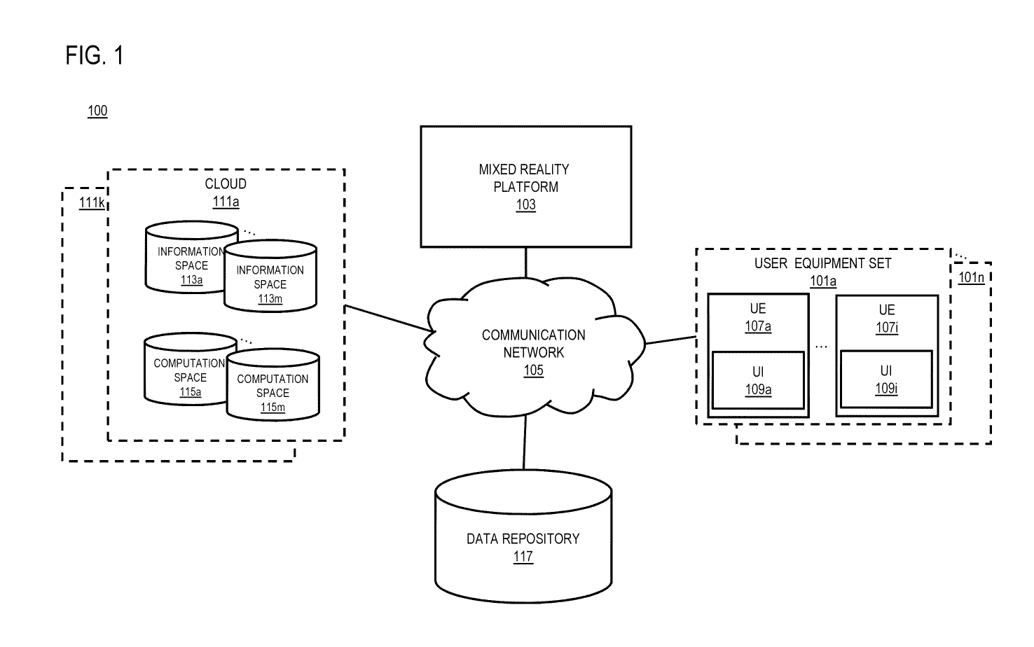

FIG. 1 is a diagram of a system capable of providing local synchronization of information for augmented reality objects, according to one embodiment. As noted above, location-based services for mobile devices and computing devices in general are becoming ubiquitous. These services, for instance, can include augmented reality and mixed reality services and applications. In one embodiment, augmented reality is a special case of mixed reality that enables a user's view of the real world to be overlaid with additional visual information. Mixed reality allows for the merging of real and virtual worlds to produce visualizations and new environments. In mixed reality, physical and augmented reality objects can co-exist and interact in real time. Thus, mixed reality can be a mix of reality, augmented reality, virtual reality, or a combination thereof.

A benefit of using such applications allows for the association of content to a location, or to one or more structures (e.g. buildings, roads, etc.) in the location, wherein the structure is part a virtual world that may be presented as a three dimensional (3D) object. The content may be shared with others or kept for a user to remind the user of information. Typically, the more precise a structure is defined, the more useful the content.

Traditionally, such content for constructing augmented reality views are stored, for instance, in a central database in the cloud. For example, a seamless interaction system between a user and mixed reality is built with several subcomponents naturally combined such as mixed reality scenery, a number of home screens in the mobile or nomadic device, backend support provided by a certain cloud infrastructure and corresponding API extensions, and some other nomadic device with similar capabilities. One approach to central storage includes provisioning a server to act as a federator of markup files describing AR scenes. The server then responds to client queries for augmented reality information by returning links to the relevant markup files. However, depending on network traffic and computing resources, server response to client queries may be affected by response time and latency issues. For instance, in cases where there is dynamic locally relevant information that changes rapidly, the response times and latency provided by the server may make it challenging to provide up-to-date local information in a timely manner.

To address this problem, a system 100 of FIG. 1 introduces the capability to synchronize information or data that is stored locally within nomadic or stationary devices for display in AR or mixed reality environments. In one embodiment, the various embodiments described herein enable synchronization of local information or data (e.g., data stored at client devices as opposed to data stored on network-side data repositories) via a “launch pad” area of AR applications. In one embodiment, the launch pad is an application element that enables dragging of an augmented reality object from augmented reality views or other mixed reality screens for manipulation. For example, once a augmented reality object is within a launch pad area, the process of augmented reality object decomposition takes place. In this way, a launch pad can work as a primary parser, execution strategy enabler, and/or process mapper for the augmented reality objects and related data (e.g., local information or data).

By way of example, users may see access to dynamic locally relevant information as an important aspect of AR or mixed reality applications. Accordingly, such a need speaks in favor of local storage and synchronization (as opposed to global cloud storage only) for the local information. For example, local storage enables fast access and synchronization between local UEs 107, between UEs 107 and local storage, etc. In one use case, local storage, sharing, and/or synchronization of information can be relevant for mobile users passing each other and crossing momentarily where the time for representing the passing users in local mixed realities or augmented realities can be short or immediate. In other words, local storage, sharing, and synchronization of augmented reality information can be indicated in circumstances where there is the potential for rapidly changing data such as when AR views meet, AR layers are (at least partially) overlapping with relevant location information such as AR tiles, map tiles, and/or selected local connectivity options.

In one embodiment, the system 100 enables synchronization of local items or data allocated in the launch pad for temporal and/or spatial mapping onto AR streams and/or consumer specific functional flows (e.g., chains of computation closures that perform or execute operations on data) maintained within nomadic or stationary devices. This process, for instance, brings locally stored AR information into active use among the synchronized devices. In one embodiment, the synchronization of locally stored AR information is used with local run-time environments and data storage infrastructure. For example, the local run-time environment and data storage infrastructure may be distributed or locally aggregated. In some embodiments, the environment and infrastructure may be distributed across other infrastructures with which a device is connected such as coexistence managers of a cognitive connectivity infrastructure. In addition or alternatively, in some embodiments, connectivity via short range radio systems can be used (e.g., radio frequency memory tag systems) to exchange information via physical objects to which data or information is bounded.

In one embodiment, local information to be exchanged or synchronized is launchpad content if the content items are associated/mapped against certain augmented reality objects within an augmented reality view or local run-time environment. For example, if one user has content (e.g., local information) that other users would want to have, the system 100 can enable local synchronization of the shared content. In one embodiment, the content can be shared or synchronized using touch and information exchange via, e.g., radio frequency memory tags such as near field communication (NFC) tags or other short-range radio technology.

In one embodiment, launch pads, AR views, AR layers, etc. associated with local information or content are synchronized via a system launch pad. Such content includes, for instance, locally stored content as well as metadata describing locally or regionally specific parameters (e.g., frequency, expiration times, amount, permissions, etc.) governing the synchronization. In one embodiment, the system 100 can enable or associate different synchronization parameters for different AR layers or views. According to the parameters, the launch pad provides updates, composition activities, (e.g., for sending synchronization updates to AR layers or views) and decomposition activities (e.g., for updates to local computation closure primitives). In one embodiment, the system 100 can define lifetime or other operational parameters for the composition/decomposition activities as well as to the launch pad itself.

In one embodiment, locally stored, shared, and/or synchronized information may include representations (e.g., media representations such as graphical, audio, etc.) of other devices or users if any are, for instance, present in the AR views or layers presented on a device. In some embodiments, the representation or local information may include sensitive or personal data that can be restricted based on privacy and/or security policies operating at the devices. In other words, whether a user is presented with certain local information is based on whether that user is allowed to view, access, or otherwise interact with the information.

In some embodiments, the local information or data to be stored, shared, and/or synchronized may be large in size (e.g., video or other binary content). In this case, the system 100 enables bifurcating the synchronization of local information into lightweight data (e.g., primarily metadata) and the bulky or heavy portion of the data (e.g., binary data) for synchronization using different schemes. For example, lightweight data may be stored, shared, and/or synchronized using radio frequency memory tags, while the synchronization of the associated bulky or heavy data is offloaded by means of any short and/or mid-range communication means.

In one embodiment, the system 100 ties storage, sharing, and/or synchronization of local information to specific interactions with artifacts/augmented reality objects. In one embodiment, the interactions may include the number of artifacts/augmented reality objects that are tapped, dragged to a user and/or mixed reality launch pad, or matched to the results of a query. For example, the system 100 may include a query input area (e.g., a free form query input area, a one line search area, a URL link to a number of objects, or a combination thereof) as form of interaction with augmented reality objects.

In one embodiment, for the purpose of decomposition of a augmented reality object (e.g., from an augmented reality information space), a certain virtual area, presented and supported by the user equipment can be utilized (e.g., a launch pad area), where the augmented reality objects can be parsed in order to map the data and computational parts associated with storage, sharing, and/or synchronization of local information against computational ontology used by participating devices and respective functional elements. Furthermore, the functional elements can be provided by the user equipment or by any other computing devices, for example, one or more neighbor devices over some communication means, a server in the cloud, etc. or a combination thereof.

In one embodiment, the augmented reality objects presented and exposed by the mixed reality platform 103 are constructed from the data and respective processes presented with computation closures of computation spaces, enforced with particular decomposition techniques, while applying relevant privacy adjustments.

As shown in FIG. 1, the system 100 comprises sets 101a-101n (also collectively referred to as sets 101) of user equipment (UEs) 107a-107i (also collectively referred to as UEs 107) having connectivity to the mixed reality platform 103 via a communication network 105. In one embodiment, the mixed reality platform 103 and/or other components of the system 100 consist of several subcomponents to form a seamless architecture between location, mixed reality, and connectivity. By way of example, these subcomponents are combined in the mixed reality platform 103 and include: map tiles, mixed reality tiles (in the UEs 107), and connectivity options (e.g., from cognitive radio (CR) to close proximity connections) with backend support provided by certain cloud infrastructure (e.g., cloud 111a-111k), corresponding application programming interface (API) extensions, and other UEs with similar capabilities. This is to provide, for instance, appropriate system connectivity, memory, and processing power provisioning that focuses on local AR operations (e.g., for instant moments; or when mixed realities of two or more systems meet and they need to share local information momentarily for a selected operation, time, place, or target for both mixed realities).

In one embodiment, the mixed reality platform 103 and/or the system 100 forms a baseline to construct mesh granularity for dynamic computations to support, for instance, proper computations at/to the edges of a distributed architecture. In such an architecture, the system 100 utilizes prefetched regional data structures and regional databases and with appropriate endpoint structures. As previously noted, in one embodiment, the system 100 takes as a baseline the notion of composition of augmented reality objects with the possibility of creating (e.g., less or more used, dense) artifacts (or artifact clusters) with AR overlays of augmented reality objects (or clusters of objects) with different metadata sets. The system 100 also includes encapsulation of the augmented reality objects and related computation closures for those purposes. In one embodiment, such augmented reality objects consist of data and computations with interaction results formed when combining map tiles with mixed reality tiles and the available connectivity options.

In one embodiment, dynamic operations are derived from AR layers or views of two or more local augmented realities being under the same coverage, using the same local connectivity options for an instant moment, etc. By way of example, computational activities are derived based on how density of the following components: map tiles, mixed reality tiles, and connectivity between “client” and “server” (e.g., within a local context).

In one embodiment, the mixed reality platform 103 provides mapping of augmented reality objects, runtime executions, associations, synchronizations, resource use for rendering AR views, and/or density of computation links (e.g., between UEs 107 and different parts of the local domain such as other neighboring UEs 107). In this context, dragging augmented reality objects to a launch pad area enables decomposition of the dragged objects/blocks along with related computations. In one embodiment, the launch pads, AR views or layers, etc. are synchronized via a system launch pad to store, share, and/or synchronize local information or content and associated metadata with regional or local specific parameters.

In one embodiment, the architecture of the system 100 enables formation of different endpoint layers (e.g., core layer, service layer, edge layer, etc.) for different content sharing, locations, mixed local realities, and/or connectivity options. As previously noted, the system 100 also enables different synchronization needs associated with different AR views or layers.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, close proximity network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.). In one embodiment, the UEs 107 may be devices embedded or installed in vehicles such as car dashboards, removable tablets, personal navigation devices, smartphones, etc.

In one embodiment, the UEs 107a-107i are respectively equipped with one or more user interfaces (UI) 109a-109i (also collectively referred to as UIs 109). Each UI 109a-109i may consist of several UI elements at any time, depending on the service that is being used. By way of example, UI elements may be icons representing user contexts such as information (e.g., music information, contact information, video information, etc.), functions (e.g., setup, search, etc.) and/or processes (e.g., download, play, edit, save, etc.). These contexts may require certain sets of media dependent computation closures, which may affect the service, for example the bit error rate, etc. Additionally, each UI element may be bound to a context/process by granular distribution. In one embodiment, granular distribution enables processes to be implicitly or explicitly migrated between devices, computation clouds, and other infrastructure. Additionally, a UE 107 may be a mobile device with embedded Radio Frequency (RF) tag system of device to device connections such that computational operations and content can be locally transmitted among devices, where devices can be peer devices, accessories, mobile readers/writers, or a combination thereof (e.g., via device to device touches). Additionally, the computational operations and content transmissions can be between devices and tags, where content read/write takes place among devices and tags, with minor or no computational operations at tag side. In one embodiment, the computation closures associated creating/detecting behavioral patterns, providing assistance results, etc. may be exchanged from device to device RF tags (e.g., near field communication (NFC) tags).

In one embodiment, the process of interaction between a user of UE 107a-107i and mixed reality may consist of several stages of operations such as, for example, bootstrapping, usage, end titles, etc. In one embodiment, the bootstrapping operation may include augmenting a scene (e.g. a video stream, an audio stream, one or more still images, etc.) with anchors, wherein anchors are empty artifacts or augmented reality objects. The bootstrapping operation may also include definition of augmented reality objects and attaching them to the selected anchors. The user may define a certain number of augmented reality objects in an augmented reality view with associated data and computations.

In one embodiment, during the usage operation a user of UE 107a-107i is enabled by the mixed reality platform 103 to select and drag augmented reality objects in order to undertake certain actions. For example, a user interested in museum tours, may select a certain museum, select a route to the museum, select points of interest associated with the museum, check the schedules associated to the points of interest and check whether the schedules are based on invitation or for the public. The user may be also given the capability to update existing augmented reality objects by injecting a new or updated augmented reality object into a data repository 117 or other storage areas managed by the mixed reality platform 103. In one embodiment, the update of existing augmented reality objects can be facilitated by storing, sharing, and/or synchronizing local information as discussed with respect to the various embodiments described herein.

In one embodiment, a user is enabled to define a subset of augmented reality objects with restricted view (number of properties). It is noted that, a restricted area may have no augmented reality objects or may not be justified according to the user's personal settings.

In one embodiment, results from/to augmented reality objects that are dragged between user and mixed reality are gathered. Such augmented reality objects consist of data and computations. Interaction results are gathered when object is dragged to a dedicated area, or to the right place of a scenery (e.g. from mixed reality to home screens or vice versa). Augmented reality objects gather results from initial computations at home screen and updated objects are dragged back to mixed reality. This provides interactions, computations and service discovery. Additionally, one or more augmented reality objects may be enabled in mixed reality after an RF tag has been touched in real world.

In one embodiment, a user can control the details that are pushed to the provider (shown in the mixed reality). The style and outlook of these realities can be different, for example sliced, with or without borders, increased and decreased outlooks, etc.

In one embodiment, the augmented reality objects are generated by the mixed reality platform 103 via basic projection and injection functionalities. In order to project from one or more information spaces 113a-113m (also collectively referred to as information spaces 113), one or more computation spaces 115a-115m (also collectively referred to as computation spaces 115), local storage at the UEs 107, or a combination thereof, a partitioning function can be used. Similarly, in order to return the contents of a projected information space or computation space back into the space, the projected space is injected back under a filter. The filter removes any inserted information or computation that is not to be injected. The injection also induces a merge of information over any projected spaces, where multiple spaces exist.

In one embodiment, seamless interaction between the user and mixed reality is used for rich media content processes, and for determination what users require from mixed reality scenes and communications.

In one embodiment, projection and injection of the user and mixed reality forms local synchronization operations between the realities. In case of projection, a triggering event, for example provided by a query, is received for projecting computation closures from an augmented reality computation space 115a-115m, representing a augmented reality object. As previously described, in one embodiment, the computation closures associated with storing, sharing, and/or synchronization local information are serialized or otherwise encapsulated in the augmented reality objects.

In one embodiment, a subset of information content from the augmented reality information space 113a-113m associated with a augmented reality object is extracted by using a partitioning function. Furthermore, a run-time information space is created in cloud 111a-111n using the extracted subset of information content. In one embodiment, the information space extracted from the cloud 111a-111n can be integrated or mixed with information that is locally synchronized among proximate or neighboring devices.

In one embodiment, an injection operation includes receiving a triggering event, for example a query, to inject computation closures into an augmented reality computation space 115a-115m. Prior to the injection, it is determined whether the computation closure and the augmented reality computation space exist. Furthermore, if the closure and the augmented reality information/computation spaces exist (e.g., in local storage at one of the devices), it is determined whether the computation closure is on a list of information/computation spaces projected from the augmented reality information/computation space.

In another embodiment, if the computation closure is on the list of information/computation spaces projected from the augmented reality information/computation space, a filtering function is applied on the information content of the computation closure and any other information spaces projected from the augmented reality information space. Additionally, the filtered information content is added to the information content of the augmented reality information/computation space.

In one embodiment, any artifacts within the pointing direction of an input equipment (e.g., camera, camcorder, microphone, etc.) are selected to detect any augmented reality objects that are projected and or injected between user and mixed realities. For example, when a mobile device points to a magazine including information such as brand name, certain text, picture etc., it picks up various artifacts from the pointing direction (coverage, scenery). The mixed reality platform 103 can detect which augmented reality objects are available. It is also able to make implication analysis of when and how objects information is dragged out.

In one embodiment, the mixed reality platform 103 can determine what objects to make available based on local information that has been stored, shared, or synchronized among proximate devices. For example, the available objects may be selected from among objects associated with a particular representation of a user or device visible in an AR view or layer. By way of example, in one use scenario, a user devices may contain local information that includes virtual clothes to represent the user when viewed through AR. In this case, as the device or user passes in the field of view of another user's device, the virtual clothes or other representation information can be locally synchronized according to the various embodiments described herein for presentation in an AR view or layer. By way of example, because movement a user or device within a field of view can be quick or transient, local synchronization (as a opposed to network data extraction for the representation) may provide better response times and decrease latency. In some cases, the representation or other local information may be subject to restrictions based on privacy and/or security policies or preferences.

In one embodiment, one or more functional elements for the event/object are set, wherein the object is read as data, the process that is going to be applied on the data is determined and the functional element is formed based on the data and the determined process. For example, computation closures from computation spaces 115a-115m can be utilized as fine grain processing mechanisms to describe projection and injection. It is noted that projection and injection are baseline functions of the information spaces 113a-113m and the computation spaces 115a-115m.

In one embodiment, the mixed reality platform 103 may cover any item (e.g., augmented reality object) that can be created and updated for a user of UE 107a-107i and for the mixed reality platform 103. The augmented reality objects can be utilized by barcode readers, text recognition readers, RF memory tag readers/writers containing readable/writable augmented reality objects, etc. For example, while viewing a magazine, the name of the magazine can provide suitable item characteristics. A user of UE 107a-107i may point the UE to the magazine's brand name, certain text, picture, etc. and picks up various artifacts from the pointing direction (coverage, scenery, etc.). With reasoning applied, the mixed reality platform 103 it is able to detect what augmented reality objects are available, in the data repository 117, within the mixed reality platform 103, locally stored at the UEs 107, or a combination thereof, for the magazine's reality. Furthermore, the mixed reality platform 103 can detect implications associated with the augmented reality objects, wherein the implications are activated when object(s) information is dragged out. Additionally, the mixed reality platform 103 may recognize other data associated with the augmented reality objects, for example, data other than the bar codes.

In one embodiment, the mixed reality platform 103 can be associated with a cognitive radio system (not shown). The cognitive radio connectivity can enable transmission of context information, locations, and recognized objects in a particular event, other object and their neighborhoods. The cognitive connectivity can also be used for storing, sharing, and/or synchronizing local information affecting a user of UE 107a-107i, mixed reality projection and injection, functional elements attached to particular places, spaces, times, users, scenes, etc.

In one embodiment, data such as time, event, place, space, users, scenes, etc. associated with a specific user's personal information is taken from the user's spaces (e.g., information spaces 113 and/or computation spaces 115) such as for example user's calendar events, wherein the user can control the limited data profile available from the context specific databases. Furthermore, the selected augmented data is responded back. The user's own agent can do reasoning on selected data and provide collected entity combining the data and the reasoning with controlling functionality, to release only the minimum information needed for a process. In other words, a user of UE 107a-107i knows and controls his/her own data. It is noted that typically in augmented reality systems a high volume of data resides elsewhere and is beyond user's own control. However, the mixed reality platform 103 allows projection of data to the user's own space. A user's own data settings can be much bigger than what is retrieved to the system when a augmented reality object is dragged between the user and the mixed realities display on the UI 109a-109i. Furthermore, the information attached to the dragged object is updated to/from a launch pad area of the UI or to another particular area.

In various embodiments, the style, outlook and appearance of the user and mixed reality displays may be different based on operations done with projection and injection activities such as, for example, sliced equally (or ⅓, picture in picture), with outlook borders, increased and decreased outlooks depending on the projection or injection functionalities, etc. Therefore, the outlook and style can adapt to the focus point selected by the user.

Furthermore, projection and injection may include transmission of mixed reality identifies and delivering preliminary metadata associated with the object, if the metadata exist, to/from a launch pad, pulling selected area or object to the launch pad (from mixed reality screen to user reality home screen launch pads, or vice versa), selecting or turning the object direction, where to drag (from mixed reality display to user reality home screen or vice versa) if necessary, or a combination thereof. Additionally, a user may have the ability to tap other objects, move all tapped object to the launch pad, and tap the launch pad area, to retrieve context menu or a drop down list.

In one embodiment, several subcomponents such as local information, mixed reality scenery, a number of home screens in the mobile or nomadic device, backend support provided by a certain cloud 111a-111n infrastructure and corresponding Application Programming Interface (API) extensions, some other nomadic device with similar capabilities, etc. are naturally combined, for instance, to provide the functions and/or user interfaces of the various embodiments described herein.

In one embodiment, an operational mode of the mixed reality platform 103 consists of observing augmented reality stream with augmented reality objects or anchors. The augmented reality window can be adjusted in either two or more views tiled along the sides of each other, where at least one should represent a home screen with application launch pad.

In various embodiments, operations are bi-directional, wherein the functional properties along with relevant data can be gathered from one or more home screens and either a certain augmented reality object can be associated or new augmented reality objects can be created.

In one embodiment, augmented reality objects can be placed back to the augmented reality side (screens) wherein the object can update already existing augmented or augmented reality objects or can be placed in newly defined and activated anchors.

In one embodiment, a home screen can hold several applications (functional chains constructed out of the computation closures and connected into branches).

In one embodiment, once a augmented reality object is dragged from augmented reality screen to home screen the following may occur:

A{Adata,Acomp}→decompose{A}→{Adata,Acomp,Map[Adata],Map[Acomp],ExecStrategy,Branches,Options} (1)

wherein A is a augmented reality object compose of data, Adata and computation closures Acomp. The augmented reality object A is then decomposed into Adata, Acomp (Adata and Acomp are allocated according to a particular runtime environment), Map[Adata] and Map[Acomp] are parsed with process mapper in order to determine certain executables to be executed against the Adata. The ExecStrategy is constructed and updated with a mapping of execution results. The Branches and Options represent number of branches and number of options and are taken into the functional chains selection process before actual execution starts.

In one embodiment, once the functional elements are gathered on a home screen, the process of migration and projection takes place, as a reverse of the decomposition process (1). Furthermore, the size and the position of augmented reality screen can be adjustable as seen in exemplary embodiments discussed below.

By way of example, the UEs 107a-107i, and the mixed reality platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

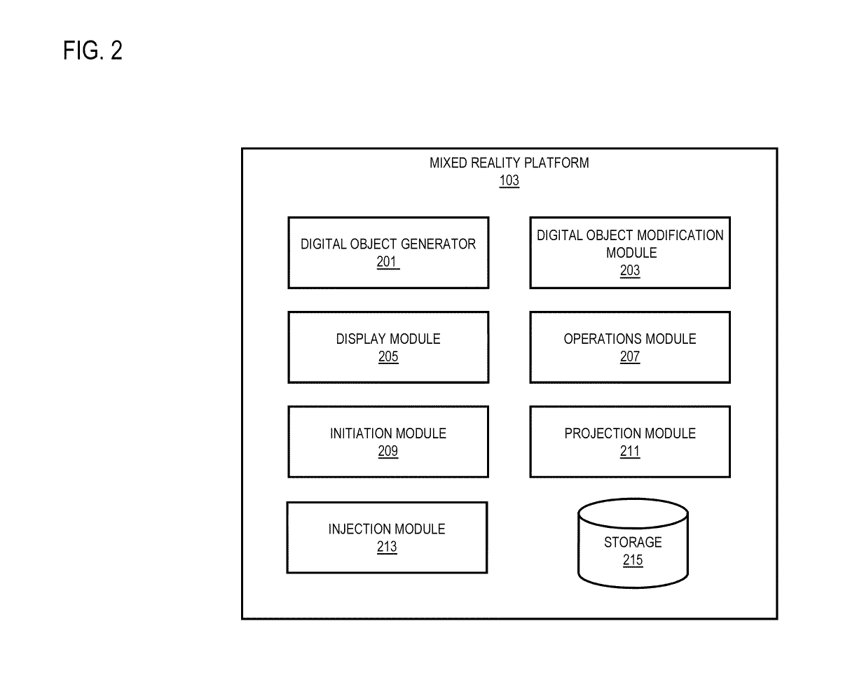

FIG. 2 is a diagram of the components of the mixed reality platform, according to one embodiment. By way of example, the mixed reality platform 103 includes one or more components for providing seamless interaction in mixed reality. It is contemplated that the functions of these components may be combined in one or more components or performed by other components of equivalent functionality. In this embodiment, the mixed reality platform includes a augmented reality object generator 201, a augmented reality object modification module 203, a display module 205, an operations module 207, an initiation module 209, a projection module 211, an injection module 213, and storage 215. In one embodiment, the components of FIG. 2 execute one or more algorithms for providing local synchronization of information for augmented reality objects. Example functions of these components are described with respect to the flowcharts below.

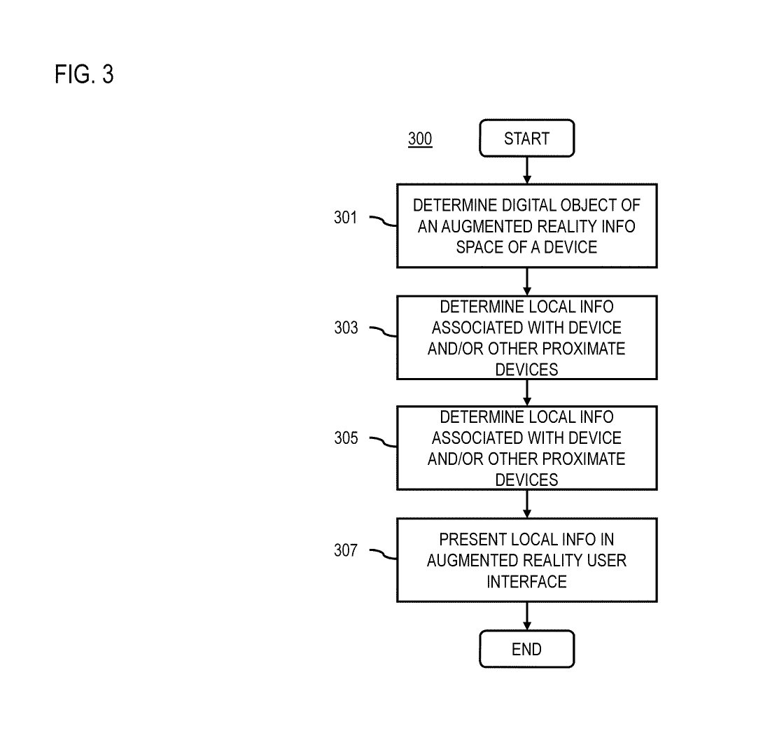

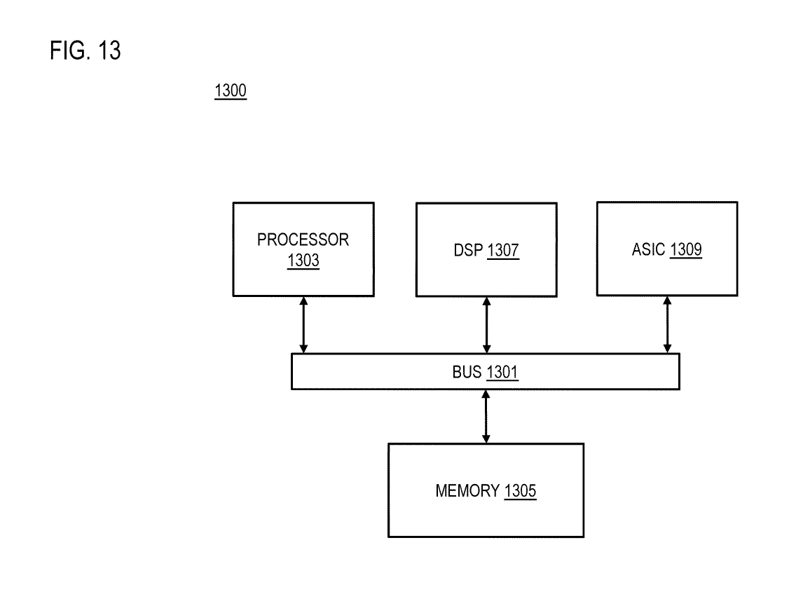

FIG. 3 is a flowchart of a process for providing behavior pattern generation for augmented reality objects, according to one embodiment. In one embodiment, the mixed reality platform performs process 300 and is implemented in, for instance, a chip set including a processing and a memory as shown in FIG. 13.

In step 301, the mixed reality platform 103 determines at least one augmented reality object of at least one augmented reality information space. More specifically, the process for determining the at least one augmented reality object of at least one augmented reality information space includes, for instance, a creation and an extraction stage of the one or more augmented reality objects. Accordingly, in one embodiment, the augmented reality object generator 201 receives or otherwise determines a triggering event to project a computation closure from an augmented reality information space 115 to represent at least one augmented reality object (e.g., an artifact). In one embodiment, the triggering event can be a query for the augmented reality object or artifact. For example, if a UE 107 is presenting an augmented reality application, the query can be triggered when the user points a camera of the UE 107 to a particular view, and requests that the mixed reality platform 103 present objects visible in the view. The query, for instance, may designate the physical location visible in the augmented or mixed reality view and then use the location information and viewpoint information to query for the appropriate objects or artifacts that may be anchored to the locations visible in the view.

In response to the triggering event, the augmented reality object generator 201 interacts with the projection module 211 to extract a subset of information content from the augmented reality information space 115 containing the desired augmented reality object or artifact. In one embodiment, the projection module 211 uses a partitioning function on the augmented reality information space 115 to extract or otherwise project the augmented reality object.

In one embodiment, the augmented reality object generator 201 determines local information from at least one device, one or more other devices proximate to the at least one device, or a combination based, at least in part, on a relevancy of the local information to the at least one augmented reality object (step 303). As previously noted, local information includes information stored at the UEs 107 in local storage as opposed to storage in the cloud-based information spaces (e.g., clouds 111). In one embodiment, the augmented reality object generator 201 determines the local information, based, at least in part, on an overlapping of one or more augmented reality views associated with the at least one device, the one or more other devices, or a combination thereof. In another embodiment, the augmented reality object generator 201 determines the local information based, at least in part, on one or more sharing preferences, one or more privacy policies, one or more security policies, or a combination thereof associated with the at least one device, the one or more other devices, or a combination thereof. The projection module 211 then extracts the portion of the local information available at participating UEs 101 that is relevant to the augmented reality object and projects the extracted local information to the augmented reality object. In one embodiment, the at least one augmented reality object aggregate, at least in part, one or more computation closures for processing the local information.

In one embodiment, the mixed reality platform 103 causes, at least in part, a synchronization of the local information, the one or more AR layers, one or more launch pad user interface elements associated with augmented reality user interface, or a combination thereof among the at least one device, the one or more other devices, or a combination thereof (step 305). In one embodiment, the synchronization is performed using one or more local connectivity means, and wherein the one or more local connectivity means include, at least in part, a cognitive radio connectivity means, a radio frequency memory tag connectivity means, or a combination thereof. For example, the mixed reality platform 103 enables creation and extraction processes to form behind the launch pad area. In one embodiment, the launch pad provides backend support, and exposes cloud processes to functional elements of the augmented reality objects if needed. In this way, the mixed reality platform 103 is able to create and update augmented reality objects that support storing, sharing, and/or synchronizing local information for user and mixed reality systems. In one embodiment, the creation and extraction stages of the augmented reality objects and synchronization of associated local information rely on computation closures and the functional chain flows arising from the computation closures.

In another embodiment, the local information includes, at least in part, lightweight data and bulky data. Under this scenario, the mixed reality platform 103 causes, at least in part, a synchronization of the lightweight data by a first connectivity means and a synchronization of the bulky data by a second connectivity means. For example, as previously discussed, the mixed reality platform 103 may use close proximity communication means (e.g., RF memory tags) to store, share, or synchronize the lightweight data and then use short or mid-range communication means (e.g., Bluetooth, WiFi, etc.) to store, share, or synchronize the bulky data.

In one embodiment, the mixed reality platform 103 causes, at least in part, an initiation of the synchronization of the local information based, at least in part, on a network connectivity failure associated with the at least one device, the one or more other devices, or a combination thereof. For example, if the mixed reality platform 103 determines that obtaining AR information from cloud-based repositories is not possible (e.g., when connectivity to the cloud is unavailable) or can result in unacceptable latency (e.g., when connectivity is slow or network bandwidth is unavailable), then the mixed reality platform 103 can initiate synchronization or determination of the information from local storage of nearby UEs 107.

In one embodiment, the mixed reality platform 103 determines one or more parameters for the synchronization separately for the one or more AR layers. By way of example, the one or more parameters include, at least in part, one or more lifetime parameters for the local information, the one or more layers, the one or more launch pad user interface elements, or a combination thereof. Other parameters may include privacy settings, security settings, user preference information, update frequency, amount of data to transmit, and the like.

Next, in one embodiment, the projection module 211 interacts with the operations module 207 to cause, at least in part, a creation of at least one run-time information space based, at least in part, on the one or more augmented reality objects or the extracted or synchronized subset of information content representing the augmented reality objects. In one embodiment, the extracted information may include locally extracted information and/or information extracted from the information space 115. The operations module 207 then, for instance, entails the run-time information space objects with descriptions of the computations associated with presentation of the augmented reality objects in an AR view or layer. For example, the operations module 207 can cause, at least in part, an entailing of representations (e.g., models, graphical representations, audio representations, multimedia representations, etc.) and other information relevant extracted locally and/or from the information space 115 to the augmented reality objects in the at least one run-time information space.

Following the entailing of the computations or the description of the computations, the augmented reality object generator 201 can ground non-wrapped computational sequences entailed in the augmented reality objects with terminations (e.g., NIL terminations, null terminations, etc.). The augmented reality object generator 201 then interacts with the injection module 213 to serialize and store the resulting computational sequences. For example, the injection module 213 can inject the serialized computational sequences in the augmented reality information space 115 for subsequent use. In one embodiment, the serialization and storage of the augmented reality objects entailed with the computations for behavioral pattern composition completes with creation process.

Following the extraction stage or process, the mixed reality platform 103 uses the augmented reality objects to cause, at least in part, a presentation of the local information as one or more layers or views of an augmented reality user interface depicting the at least one augmented reality object (step 305). In one embodiment, the mixed reality platform 103 determines the presentation of the local information for the at least one device, the one or more devices, or a combination thereof based, at least in part, on respective position information for the devices. For example, depending on the AR view or layer appropriate for the respective devices, the mixed reality platform 103 can project different views or perspectives of the local information.

In one embodiment, the augmented reality object generator 201 of the mixed reality platform 103 receives or otherwise determines a triggering event (e.g., a query as described above) for presenting the local information. In response to the triggering event, the augmented reality object generator 201 interacts with the injection module 213 to determine whether the requested computation closure and the augmented reality information space associated with the presentation of the local information exist. In one embodiment, if the computation closure (e.g., associated with a augmented reality object or artifact of interest) does not exist, the augmented reality object generator 201 can initiate the computation closure creation process described above.

In one embodiment, if the computation closure exists, the injection module 213 can determine whether the requested computation closure is on a list of information spaces projected from the augmented reality space 115 or from local storage at the UEs 107. If the computation is on the list, the injection module 213 applies, for instance, a filtering function on information content of the requested computation closure and any other information spaces projected from the augmented reality information space 115 and/or local storage. The injection module 213 then adds the filtered information content to the information content of the run-time information space.

The injection module 213 can then interact with the operations module 207 to read the serialized and stored computational sequences associated with the computation closures from the storage. In one embodiment, the operations module 207 causes, at least in part, a traversal of the one or more computation closures to present the local information. The operations module 207 then causes, at least in part, an extraction of the data, the one or more computations, or a combination thereof associated with the requested local information. In one embodiment, the composition of the augmented reality objects with the local information as described in the above processes is added to the identity of the user and the mixed reality architecture.

In one embodiment, the mixed reality platform 103 determines one or more characteristics of one or more items in at least one view of one or more augmented reality applications associated with the at least one augmented reality information space, and then determines the one or more augmented reality objects and associated local information to make available or present based, at least in part, on the one or more characteristics.

As part of the process 300, the mixed reality platform 103 sets the functional element of the augmented reality objects by, for instance, reading the functional element as data and determining what should be done with the processing components and/or the data components of the objects. In other words, computational closures are taken to be utilized as fine grain processing mechanisms to determine and present local information for augmented reality objects (e.g., to support the computation closure mechanism).

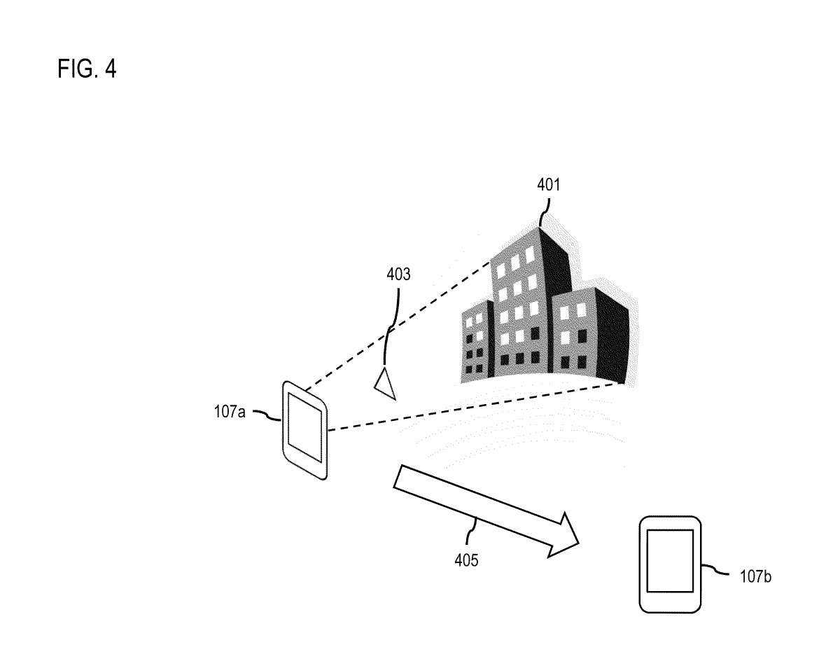

FIG. 4 is a diagram illustrating synchronization of local information associated with an augmented reality view, according to one embodiment. More specifically, FIG. 4 illustrates a process whereby multiple devices (e.g., UEs 107a and 107b) can share dynamic locally relevant information for presentation in AR views or layers for the respective devices. As shown, a UE 107a is presenting an augmented reality view of building 401 (e.g., an artifact) with a augmented reality object 403 overlaid onto the building 401. By way of example, the augmented reality object 403 presents information and content locally (e.g., a video associated with the building 401) stored on the UE 107a.

In this example, an AR application executing on the UE 107a includes a launch pad area for storing, sharing, and synchronizing locally relevant. Accordingly, a first user of the UE 107a may drag the augmented reality object 403 to the launch pad area to initiate a sharing and synchronizing of the augmented reality object 403 along with its associated local information (e.g., a video). By dragging the object to the launch pad area, the launch pad makes the object 403 and local information available for sharing through, for instance, the composition/decomposition process previously described. Then to initiate the sharing and synchronizing process 405, the UE 107a can initiate communications with the UE 107b (e.g., via a cognitive radio connectivity, radio frequency memory tag connectivity, or any other communication means available between the UEs 107a and 107b). In one embodiment, the sharing may be initiated if the UE 107b suffers a communication failure that prevents it from retrieving the AR information from cloud-based sources.

Because the local content includes video content, the synchronization may be conducted using multiple means of communication for respective lightweight and bulky portions of the video. For example, radio frequency memory tag communications may be used to synchronize metadata describing the video, while the binary data of the video is transmitted over cognitive radio connectivity.

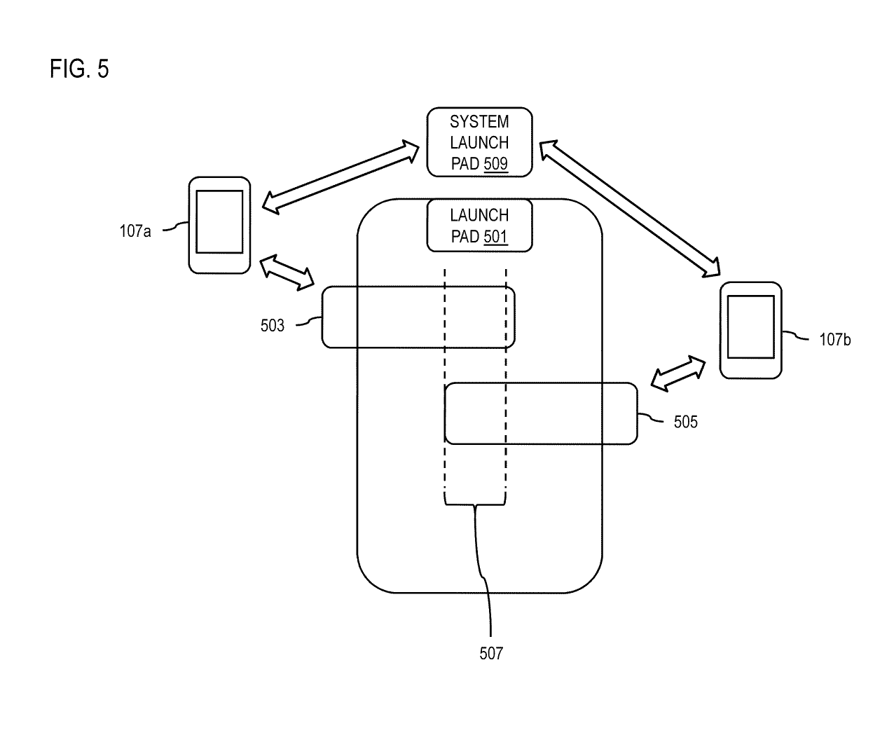

FIG. 5 is a diagram illustrating information to be shared between layers of an augmented reality overlay, according to one embodiment. To support user access to dynamic locally relevant content or information, the content can be shared between mixed or augmented realities presented respectively on UEs 107a and 107b. In this example, local information (e.g., a certain set of map tiles, AR views, and selected connectivity views) can be shared or synchronized so that rapidly locally relevant data are available via a synchronized launch pad 501. For example, the UE 107a is associated with an AR layer 503 and the UE 107b is associated with an AR layer 505. In one embodiment, the AR layer 503 and AR layer 505 are associated with local primitives encapsulating local information and computation closures.

In one embodiment, when the UE 107a and UE 107b are nearby each other (e.g., when passing by each other or crossing momentarily), the system 100 can determine an overlap area 507 of the each device's respective AR information. The overlap area represents information that, for instance, is locally relevant to each device and should be shared or synchronized between the devices. For example, the overlap area 507 may represent objects or content that are visible in the AR views of each device.

In one embodiment, the overlap area 507 of the AR layers 503 and 505 and associated launch pad 501 are synchronized via a system launch pad 509 form momentarily by the launch pad 501 for synchronization. In one embodiment, the system launch pad 509 synchronizes the local content, metadata, synchronization parameters (regionally or locally specific), etc. of the overlap area 507 between the AR layer 503 and AR layer 505. In one embodiment, the overlap area 503 represents local information that changes rapidly and can be synchronized when AR layers meet or at least partially overlap. In some cases, the overlap area 507 also represents heavy or bulky data (e.g., video, images, etc.) that are to be rendered at the AR level.

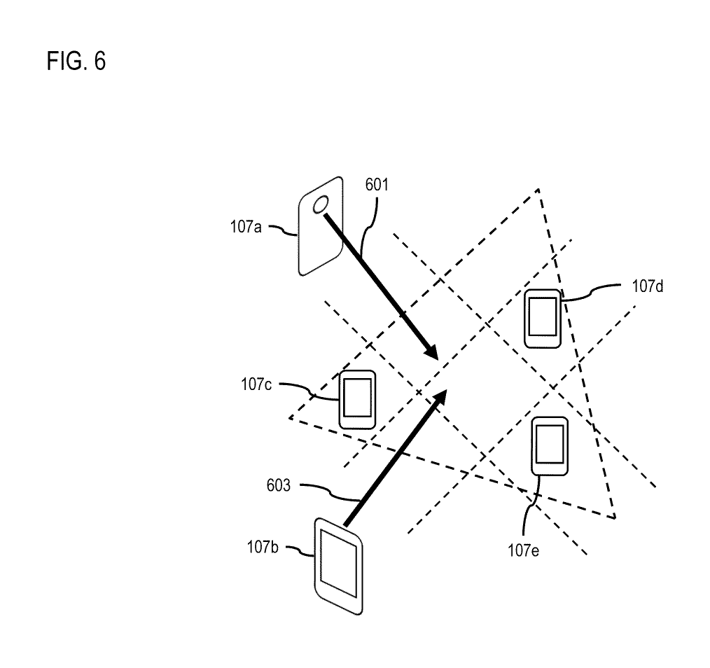

FIG. 6 is a diagram illustrating rendering of different augmented reality views for different devices, according to one embodiment. FIG. 6 illustrates an example in which UEs 107a and 107b have different AR views or perspectives in the presence of other devices (e.g., UEs 107c-107e). In this example, the respective AR views of UEs 107a and 107b can be constructed from local information synchronized from each other as well as the other nearby UEs 107c-107e. Depending on the overlapping AR views of UEs 107a-107e, each combination or permutation can respectively share respective overlapping local content. For example, the UE 107a can individually determine overlap areas with respect to UEs 107b-107e to piece or compile a more comprehensive set of local information given its specific AR view 601 or perspective. Similarly, the UE 107b can determine the overlap areas with UEs 107a and 107c-107e to synchronize and compile local AR information for presentation in its specific AR view 603 or perspective.

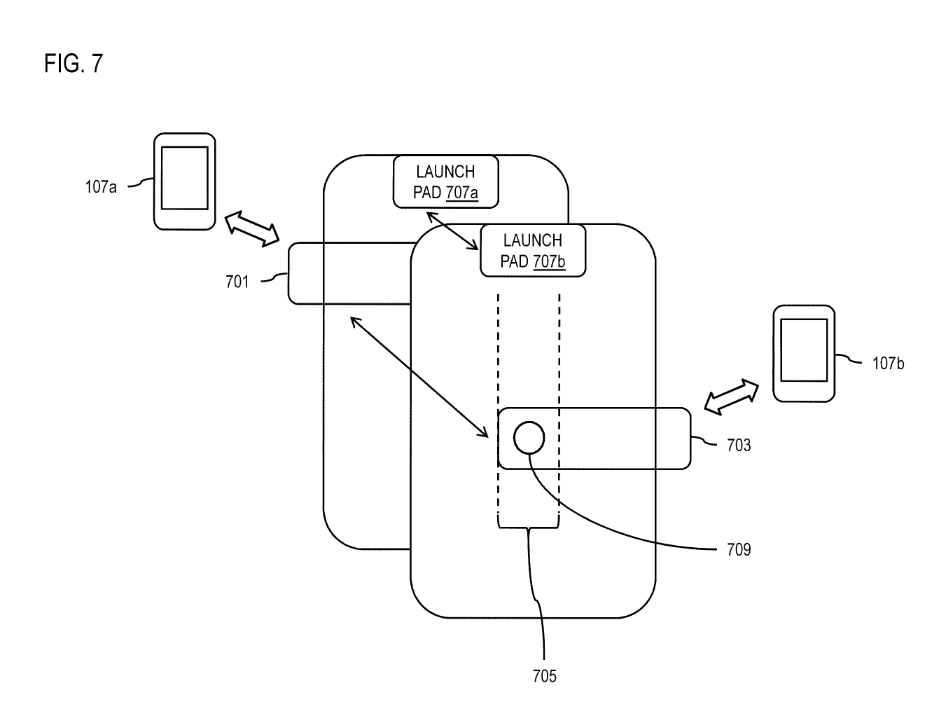

FIG. 7 is a diagram illustrating synchronization of local primitives through composition and decomposition, according to one embodiment. In one embodiment, as shown in FIG. 7, the AR layer 701 of UE 107a and the AR layer 703 of the UE 107b overlap in area 705. In this example, the overlap area 705 of the UEs 107a and 107b represent the local AR information to be shared via respective launch pads 707a and 707b. As previously discussed the launch pads 707a and 707b compose and decompose the local AR information that is to be shared as represented by the shared data 709. In one embodiment, the launch pads 707a and 707b provide updates, composition (e.g., send synchronization updates to AR layers 701 and 703) and decomposition (e.g., local primitives updates) activities on the shared data 709. In one embodiment, the launch pads 707a and 707b can be associated with different synchronization needs or parameters for the different AR layers 701 and 703. For example, there can be a defined lifetime for both the composition/decomposition activities as well as to the launch pads 707a and 707b themselves.

In one embodiment, local content metadata (e.g., including both data and computations) are synchronized and linked with regional or local specific parameters. There is a possibility to synchronize and share launch pads 707a and 707b between the two UEs 107a and 707b by, for instance, determining which launch pad 707a or 707b, or part of the launch pads 707a and 707b is shared. Because users and their UEs 707a and 707b tend to be relatively close and share the same visual context, there often is sufficient overlap of the AR layers 707a and 707b for local sharing.

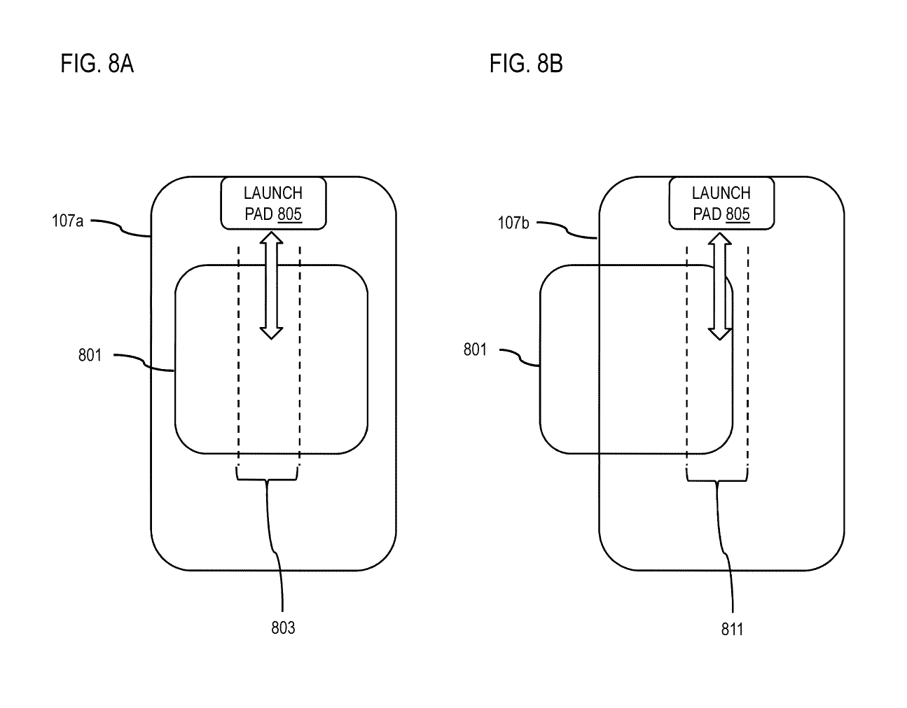

FIGS. 8A and 8B is a diagram illustrating synchronization of local information via a launch pad for a single user, according to one embodiment. FIG. 8A illustrates a UE 107a with local information in an AR layer 801. The view 803 represents the field of view over the AR layer 801 that is visible from the UEs 107a current perspective. In one embodiment, the AR layer 801 and associated local content can be synchronized with the launch pad 805 for composition/decomposition. In this example, the UE 107b is moved so that it now has a different view 811 over the AR layer 801 as shown in FIG. 8B. If the UE 107a loses connectivity to a cloud-based repository of AR information, the UE 107a via the launch pad 805 compose/decompose the portion of the previously stored AR layer 801 to construct as much of the view 811 as available.

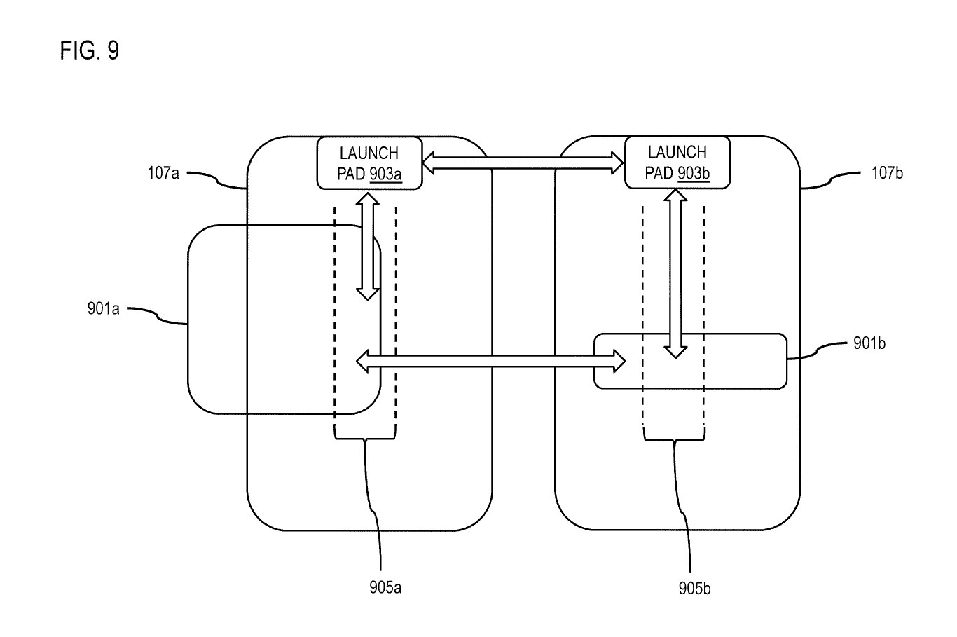

FIG. 9 is diagram illustrating synchronization of location information via launch pads of multiple users, according to one embodiment. FIG. 9 illustrates UEs 107a and 107b associated respectively with different users. As shown, UEs 107a and 107b include respective AR layers 901a and 901b each with different local AR information. The UEs 107a and 107b also include respective launch pads 903a and 903b and have different respective views 905a and 905b. In one embodiment, the system 100 provides several options for synchronizing local AR information among the AR layers 901a and 901b and launch pads 903a and 903b. For example, the AR layers 901a and 901b may synchronize information directly without participation by the launch pads 903a and 903b. In another embodiment, the AR layers 901a and 901b may be dragged to their respective launch pads 903a and 903b (e.g., for composition/decomposition). Then the launch pads 903a and 903b may synchronize with each other and then store the shared data in their respective AR layers 901a and 901b.

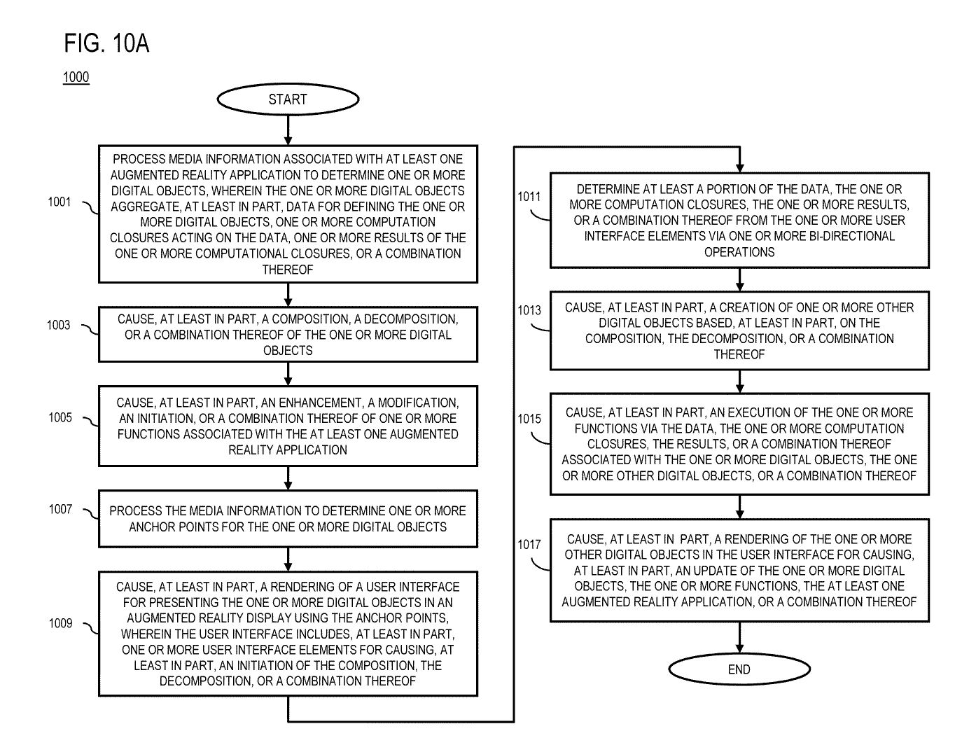

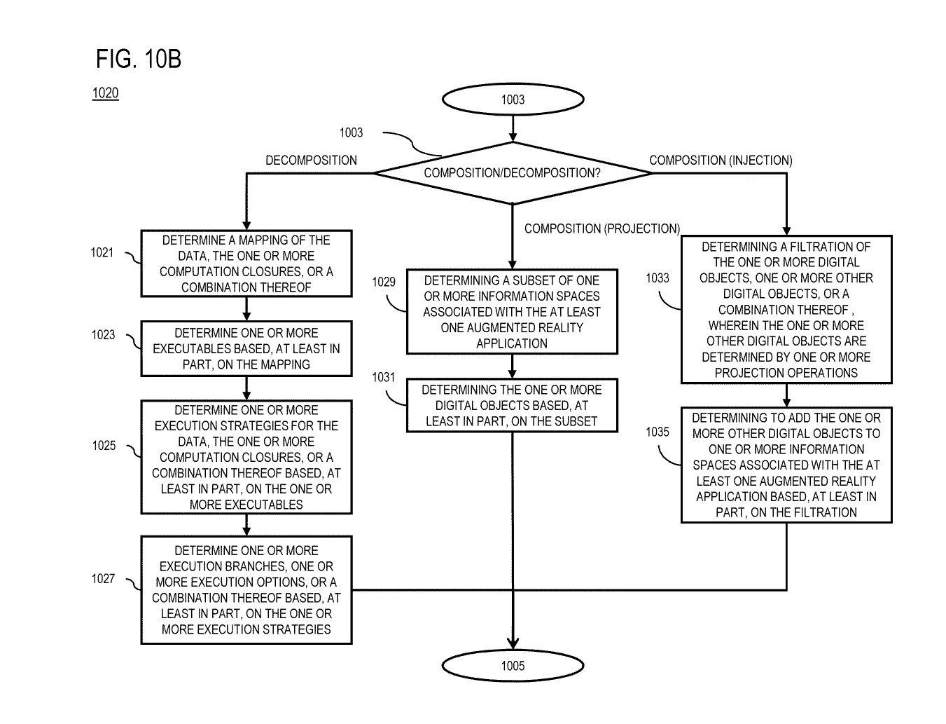

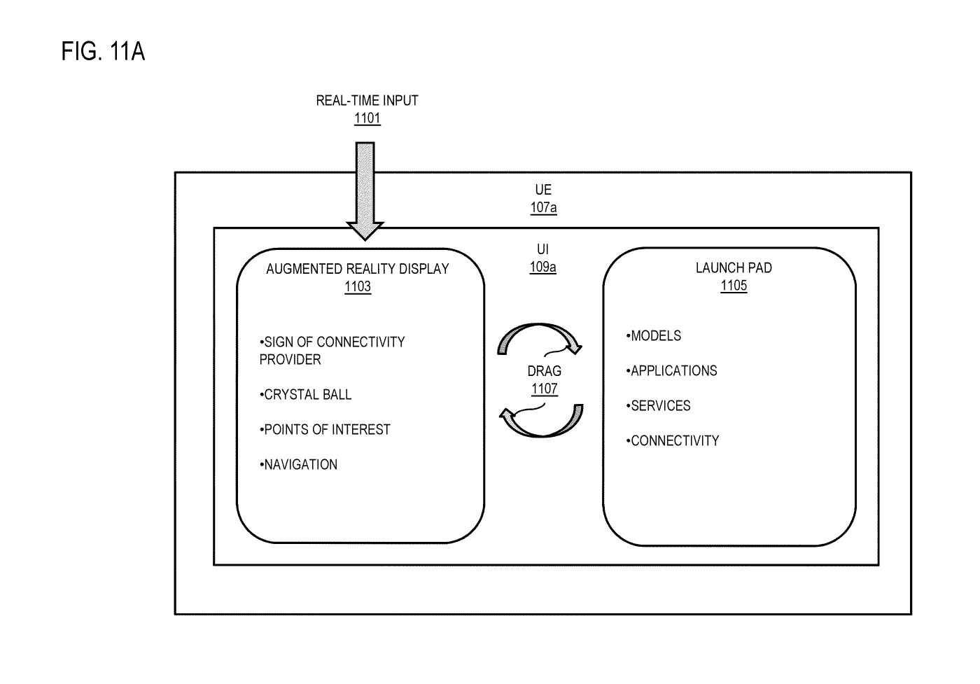

FIGS. 10A and 10B are flowcharts of a process for providing seamless interaction in mixed reality, according to one embodiment. In one embodiment, the mixed reality platform 103 performs the processes 1000, 1020 or a combination thereof and is implemented in, for instance, a chip set including a processor and a memory as shown in FIG. 13. The processes of FIGS. 10A and 10B provide a general overview for interacting with augmented reality objects in a mixed reality environment.

In one embodiment, per step 1001 of flowchart 1000 of FIG. 10A, the augmented reality object generator 201 processes and/or facilitates a processing of media information associated with at least one augmented reality application of UE 107a-107i to determine one or more augmented reality objects, wherein the one or more augmented reality objects aggregate, at least in part, data for defining the one or more augmented reality objects, one or more computation closures acting on the data, one or more results of the one or more computation closures, or a combination thereof. The data may be determined from the information space 113a-113m, from the data repository 117, from the storage 215, or a combination thereof. Similarly, the computation closures may be determined from the computation spaces 115a-115m, from the data repository 117, from the storage 215, or a combination thereof. Furthermore, the augmented reality objects, the data, the one or more computation closures, the one or more results or a combination thereof may be stored in data repository 117, in storage 215 or a combination thereof.

In one embodiment, per step 1003 of FIG. 10A, the augmented reality object modification module 203 causes, at least in part, a composition, a decomposition, or a combination thereof of the one or more augmented reality objects. The augmented reality object modification module 203, per step 1005 of FIG. 10A causes, at least in part, an enhancement, a modification, an initiation, or a combination thereof of one or more functions associated with the at least one augmented reality application of the UE 107a-107i.

In various embodiments, as seen in flowchart 1020 of FIG. 10B, the composition, the decomposition or a combination thereof of the one or more augmented reality objects may comprise application of various functions on the augmented reality objects.

In one embodiment, per step 1021 of FIG. 10B, the initiation module 209 determines a mapping of the data, the one or more computation closures, or a combination thereof. The mapping can represent the mapping that can identify relationships between the data items (e.g., between real world data and augmented reality data), between the computation closures and data (e.g., identifying the functions that are being applied on the data), or a combination thereof. The mapping results may be stored in the data repository 117, in the storage 215, or a combination thereof.

In one embodiment, per step 1023 of FIG. 10B, the initiation module 209 determines one or more executables based, at least in part, on the mapping. The executables are associated with the functions determined by the mapping. The executables may be stored in the data repository 117, in the storage 215, or a combination thereof.

In one embodiment, per step 1025 of FIG. 10B, the initiation module 209 determines one or more execution strategies for the data, the one or more computation closures, or a combination thereof based, at least in part, on the one or more executables. The execution strategies may be determined by the application providers, by the user of UE 107a-107i, by the network management entities managing communication network 105 or a combination thereof. The execution strategies may be retrieved from the data repository 117, from the storage 215, or a combination thereof. Similarly, the determined execution strategies may be stored in the data repository 117, in the storage 215 or a combination thereof.

In one embodiment, per step 1027 of FIG. 10B, the initiation module 209 determines one or more execution branches, one or more execution options, or a combination thereof based, at least in part, on the one or more execution strategies. The execution branches, execution options, or a combination may be determined by the application providers, by the user of UE 107a-107i, by the network management entities managing communication network 105 or a combination thereof. The execution branches, execution options, or a combination may be retrieved from the data repository 117, from the storage 215, or a combination thereof. Similarly, the determined execution branches, execution options, or a combination may be stored in the data repository 117, in the storage 215 or a combination thereof.

In one embodiment, the one or more functions associated with the at least one augmented reality application are based, at least in part, on the mapping, the one or more executables, the one or more execution strategies, the one or more execution branches, the one or more execution options, or a combination thereof.

In one embodiment, the mapping, the one or more executables, the one or more execution strategies, the one or more execution branches, the one or more execution options, or a combination thereof are determined, at least in part, via the one or more user interface elements such as a launch pad area, a home screen, or a combination thereof.

In one embodiment, per step 1007 of FIG. 10A, the augmented reality object generator 201 processes and/or facilitates a processing of the media information to determine one or more anchor points for the one or more augmented reality objects, wherein the anchor points are empty artifacts or place holders for the generated augmented reality objects.

In one embodiment, per step 1009 of FIG. 10A the display module 205 causes, at least in part, a rendering of a user interface for presenting the one or more augmented reality objects in an augmented reality display on UI 109a-109i using the anchor points. The user interface may include, at least in part, one or more user interface elements, wherein the augmented reality object modification module 203 can use the user interface elements to cause, at least in part, an initiation of the composition, the decomposition, or a combination thereof by the initiation module 209.

In one embodiment, the one or more user interface elements may include, at least in part, a launch pad area, a home screen, or a combination thereof on the UI 109a-109i to which the one or more augmented reality objects are moved to cause, at least in part, the initiation of the composition, the decomposition, or a combination thereof by the initiation module 209.

In one embodiment, per step 1011 of FIG. 10A, the operations module 207 determines at least a portion of the data, the one or more computation closures, the one or more results, or a combination thereof from the one or more user interface elements via one or more bi-directional operations.

In one embodiment, per step 1013 of FIG. 10A, the augmented reality object generator 201 causes, at least in part, a creation of one or more other augmented reality objects based, at least in part, on the composition, the decomposition, or a combination thereof.

In one embodiment, per step 1015 of FIG. 10A, the augmented reality object modification module 203 causes, at least in part, an execution of the one or more functions via the data, the one or more computation closures, the results, or a combination thereof associated with the one or more augmented reality objects, the one or more other augmented reality objects, or a combination thereof.

In one embodiment, per step 1017 of FIG. 10A, the augmented reality object modification module 203 causes, at least in part, a rendering of the one or more other augmented reality objects in the UI 109a-109i for causing, at least in part, an update of the one or more augmented reality objects, the one or more functions, the at least one augmented reality application, or a combination thereof.

In one embodiment, as seen in flowchart 1020 of FIG. 10B, the composition, the decomposition or a combination thereof of the one or more augmented reality objects may include, at least in part, one or more projection operations. In this embodiment, per step 1029 of FIG. 10B, the projection module 211 determines a subset of one or more information spaces 113a-113m associated with the at least one augmented reality application. Furthermore, per step 1031 of FIG. 10B, the projection module 211 determines the one or more augmented reality objects based, at least in part, on the subset.

In one embodiment, as seen in flowchart 1020 of FIG. 10B, the composition, the decomposition or a combination thereof of the one or more augmented reality objects may include, at least in part, one or more injection operations. In this embodiment, per step 1033 of FIG. 10B, the injection module 213 determines a filtration of the one or more augmented reality objects, one or more other augmented reality objects, or a combination thereof, wherein the one or more other augmented reality objects are determined by one or more projection operations. Furthermore, per step 1035 of FIG. 10B, the injection module 213 determines to add the one or more other augmented reality objects to one or more information spaces 113a-113m associated with the at least one augmented reality application based, at least in part, on the filtration.

Additionally, it is noted that, the intermediate and the final data, computation closures and, results, from the process described in FIGS. 10A and 10B may be retrieved and/or stored in storage 215, in data repository 117, in clouds 111a-111n or a combination thereof.

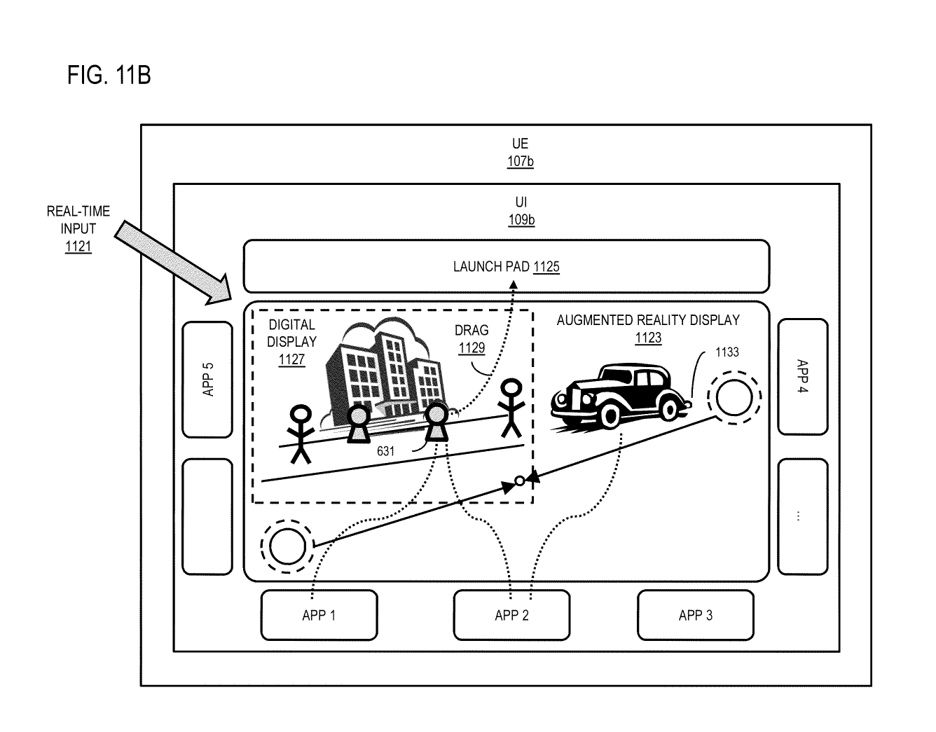

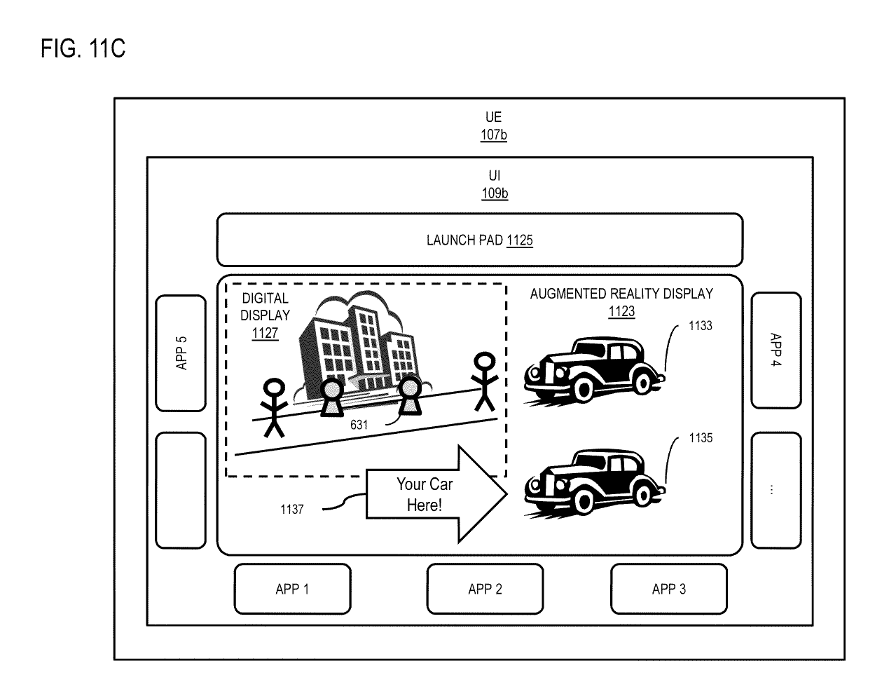

FIGS. 11A-11C are diagrams of user interfaces utilized in the process of FIGS. 1-10B, according to various embodiments.

In one embodiment, as seen in FIG. 11A, a real-time input 1101 (e.g. a video stream, an audio stream, one or more still images, etc.) is captured by the UE 107a and entered UI 109a. The mixed reality platform 103 generates augmented reality objects associated with the input and presents the augmented reality objects in the augmented reality display 1103. The augmented reality display 1103 may also represent functions that can be applied on the augmented reality objects. Some of the functions can be determination of points of interest, navigation, etc. It is noted that the input may be an already recorded media file such as a video file, an audio file, one or more still images, or a combination thereof.

In one embodiment, a user of the UE 107a can drag icons representing augmented reality objects on the augmented reality display 1103 into one or more launch pads 1105. The dragging is shown by arrows 1107.

In one embodiment, a behavioral pattern can be tied to the number of items tapped, or dragged via arrows 1107 by a user of UE 107a and mixed reality launch pad 1105, or matched to the results of a query by the user.

In one embodiment, the UI 109a of UE 107a may include free form of input query area, a one line search, a query area, a URL link to number of objects, or a combination thereof. A user of UE 107a may want to stick to the country specific device, or access extra services for example with Google translation between different languages and based on runtime settings.

In one embodiment, upon the determination of the functional elements the projection and injection data, including functional elements, are dragged to a launch pad area 1105 on the UI 109a for reasoning user and mixed realities to digital composition. A launch pad 1105 may have the capability of creating and updating augmented reality objects between the UE 107a and the mixed reality platform 103. Furthermore, the launch pad 1105 may provide backend support and expose processes associated with clouds 111a-111n to the functional elements, if needed.

In one embodiment, projection and injection mechanisms consist of a set of actions such as, for example, selecting the focus point from user or mixed reality display 1103, tapping the selected object, dragging or moving (607) the object to the launch pad 1105, locating the objects from the launch pad 1105, or a combination thereof.

FIG. 11B shows a user interfaces utilized in the process of FIGS. 1-10B with a design that is different from the interface of FIG. 11A. In one embodiment, as seen in FIG. 11B, a real-time input 1121 (e.g. a video stream, an audio stream, one or more still images, etc.) is captured by the UE 107b and entered UI 109b. The UE 107a displays the input on the digital display 1127 while the mixed reality platform 103 generates augmented reality objects associated with the input and presents the augmented reality objects in the augmented reality display 1123. In this embodiment, the augmented reality display 1123 is an extension of the digital display 1127 and the mixed reality platform 103 may provide services to the user of UE 107b to toggle between the digital display 1127 and the augmented reality display 1123 wherein the digital display 1127 shows the objects as they are in the input 1121 while the augmented reality display 1123 may allow the user to apply various functions on the objects and see the results simultaneously and enable the user to compare the objects before and after the application of functions. As seen in FIG. 11B applications APP1, APP2, APP3, APP4 and APP5 are available on UE 107b wherein APP1 and APP2 are applied on object 1131 and APP2 involves objects 1131 and 1133. It is noted that the input may be an already recorded media file such as a video file, an audio file, one or more still images, or a combination thereof.

In one embodiment, a user of the UE 107b can drag icons representing augmented reality objects on the digital display 1127, on the augmented reality display 1123, or a combination thereof into one or more launch pads 1125. The dragging is shown by arrows 1129. The results from applying the applications APP1 and APP2 on object 431 may be presented on the launch pad 1125.

In the embodiment of FIG. 11B, the APP2 involves object 1131 and the augmented reality object 1133. For example, the APP2 may be a mixed reality game using a real object 1131 and an augmented reality object 1133 played on the launch pad 1125.

In various embodiments, the mixed reality platform 103 may enable the user of UE 107b to modify the size, number and location of the digital display 1127, the augmented reality display 1123, the launch pad 1125, or a combination thereof.

FIG. 11C illustrates the user interface of FIG. 11B as used to provide assistance results for proximity navigation based on user behavioral patterns. As shown, FIG. 11C is an example use case in which a user has just exited a store and is now searching for where the user's car is parked. In the augmented reality display 1123, there are two augmented reality objects representing two possible cars (e.g., object 1133 and object 1135) that potentially belong to the user. In this example, the user's car as represented by object 1135 is equipped with a smart dashboard that can provide rendering assistance results to the user's device (e.g., UE 107b).

Accordingly, as the user approaches the car, the object 1135 (e.g., a source device) determines that approach of the user is compatible a behavioral pattern that indicates the user is searching for his or her car. For example, the behavioral pattern may have been detected or learned according to the various embodiments of the processes described above. The mixed reality platform 103, for instance, may have learned that when a user exits a store and points the UE 107b in the direction of the car object 1135, the user is likely to be searching for the car.

On detecting, the behavior pattern the car object 1135 can initiate computational processes to provide assistance results to the UE 107b to help locate the car. In this case, the source device (e.g., the smart dashboard of the car) renders assistance to the UE 107b by providing information content that results in display of a augmented reality object 1137 in the augmented reality display 1127 that points specifically to the car object 1135 that the user is searching for.

The processes described herein for providing local synchronization of information for augmented reality objects may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

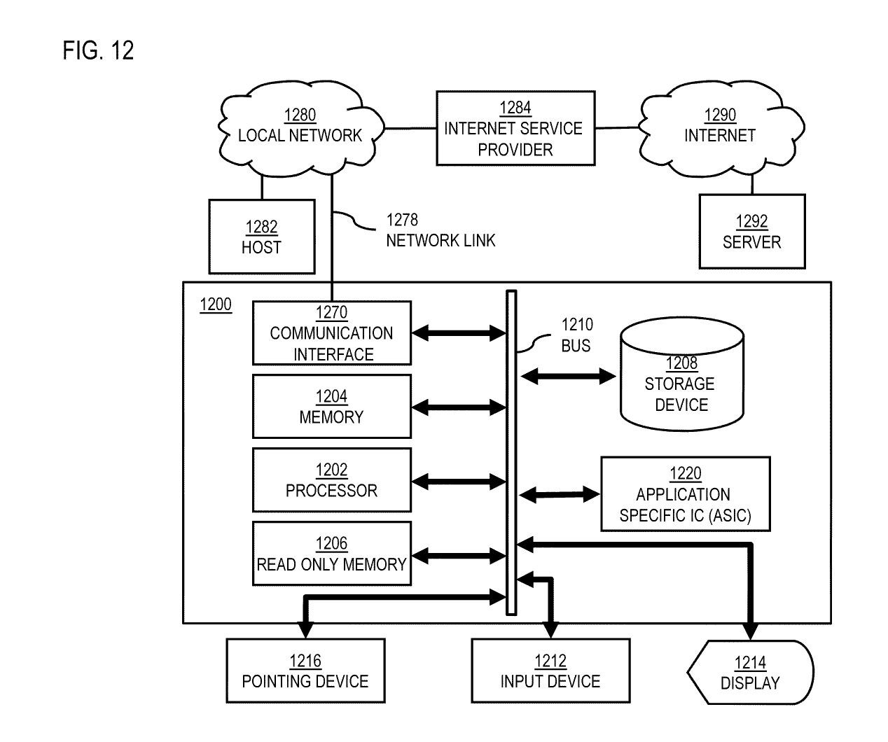

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to provide local synchronization of information for augmented reality objects as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of providing local synchronization of information for augmented reality objects.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to providing local synchronization of information for augmented reality objects. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or any other dynamic storage device, stores information including processor instructions for providing local synchronization of information for augmented reality objects. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for providing local synchronization of information for augmented reality objects, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 105 for providing local synchronization of information for augmented reality objects to the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to provide local synchronization of information for augmented reality objects as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of providing local synchronization of information for augmented reality objects.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide local synchronization of information for augmented reality objects. The memory 1305 also stores the data associated with or generated by the execution of the inventive steps.

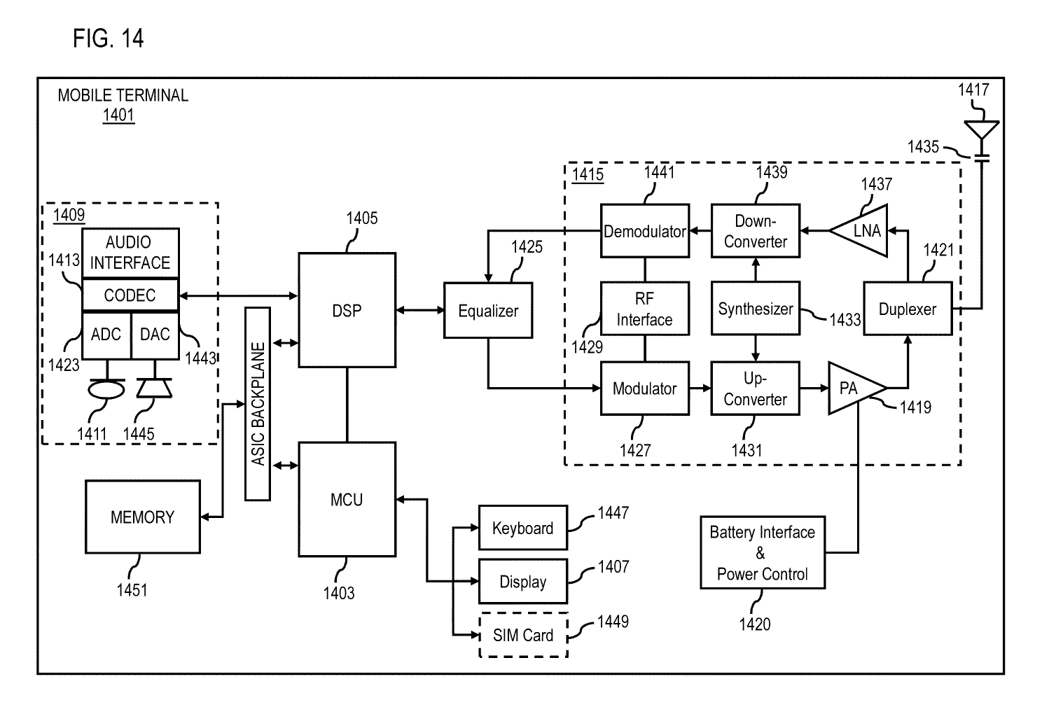

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of providing local synchronization of information for augmented reality objects. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of providing local synchronization of information for augmented reality objects. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to provide local synchronization of information for augmented reality objects. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination of at least one augmented reality object of at least one augmented reality information space;
at least one determination of local information from at least one device, one or more other devices proximate to the at least one device, or a combination based, at least in part, on a relevancy of the local information to the at least one augmented reality object; and
a presentation of the local information as one or more layers of an augmented reality user interface depicting the at least one augmented reality object.

2. A method of claim 1, wherein the (1) data and/or (2) information and/or (3) at least one signal are further based, at least in part, on the following:
a synchronization of the local information, the one or more layers, one or more launch pad user interface elements associated with augmented reality user interface, or a combination thereof among the at least one device, the one or more other devices, or a combination thereof.

3. A method of claim 2, wherein the synchronization is performed using one or more local connectivity means, and wherein the one or more local connectivity means include, at least in part, a cognitive radio connectivity means, a radio frequency memory tag connectivity means, or a combination thereof.

4. A method of claim 2, wherein the (1) data and/or (2) information and/or (3) at least one signal are further based, at least in part, on the following:
at least one determination of one or more parameters for the synchronization separately for the one or more layers,
wherein the one or more parameters include, at least in part, one or more lifetime parameters for the local information, the one or more layers, the one or more launch pad user interface elements, or a combination thereof.

5. A method of claim 2, wherein the (1) data and/or (2) information and/or (3) at least one signal are further based, at least in part, on the following:
an initiation of the synchronization of the local information based, at least in part, on a network connectivity failure associated with the at least one device, the one or more other devices, or a combination thereof.

6. A method of claim 2, wherein the local information includes, at least in part, lightweight data and bulky data, and wherein the (1) data and/or (2) information and/or (3) at least one signal are further based, at least in part, on the following:
a synchronization of the lightweight data by a first connectivity means; and
a synchronization of the bulky data by a second connectivity means.

7. A method of claim 1, wherein the (1) data and/or (2) information and/or (3) at least one signal are further based, at least in part, on the following:
at least one determination of the local information based, at least in part, on an overlapping of one or more augmented reality views associated with the at least one device, the one or more other devices, or a combination thereof.

8. A method of claim 1, wherein the (1) data and/or (2) information and/or (3) at least one signal are further based, at least in part, on the following:
at least one determination of the local information based, at least in part, on one or more sharing preferences, one or more privacy policies, one or more security policies, or a combination thereof associated with the at least one device, the one or more other devices, or a combination thereof.

9. A method of claim 1, wherein the (1) data and/or (2) information and/or (3) at least one signal are further based, at least in part, on the following:
at least one determination of the presentation of the local information for the at least one device, the one or more devices, or a combination thereof based, at least in part, on respective position information.

10. A method of claim 1, wherein the at least one augmented reality object aggregate, at least in part, one or more computation closures for processing the local information.

11. An apparatus comprising:
at least one processor; and
at least one memory including computer program code for one or more programs,
the at least one memory and the computer program code configured to, with the at least one processor, cause the apparatus to perform at least the following,
determine at least one augmented reality object of at least one augmented reality information space;
determine local information from at least one device, one or more other devices proximate to the at least one device, or a combination based, at least in part, on a relevancy of the local information to the at least one augmented reality object; and
cause, at least in part, a presentation of the local information as one or more layers of an augmented reality user interface depicting the at least one augmented reality object.

12. An apparatus of claim 11, wherein the apparatus is further caused to:
cause, at least in part, a synchronization of the local information, the one or more layers, one or more launch pad user interface elements associated with augmented reality user interface, or a combination thereof among the at least one device, the one or more other devices, or a combination thereof.

13. An apparatus of claim 12, wherein the synchronization is performed using one or more local connectivity means, and wherein the one or more local connectivity means include, at least in part, a cognitive radio connectivity means, a radio frequency memory tag connectivity means, or a combination thereof.

14. An apparatus of claim 12, wherein the apparatus is further caused to:
determine one or more parameters for the synchronization separately for the one or more layers,
wherein the one or more parameters include, at least in part, one or more lifetime parameters for the local information, the one or more layers, the one or more launch pad user interface elements, or a combination thereof.

15. An apparatus of claim 12, wherein the apparatus is further caused to:
cause, at least in part, an initiation of the synchronization of the local information based, at least in part, on a network connectivity failure associated with the at least one device, the one or more other devices, or a combination thereof.

16. An apparatus of claim 12, wherein the local information includes, at least in part, lightweight data and bulky data, and wherein the apparatus is further caused to:
cause, at least in part, a synchronization of the lightweight data by a first connectivity means; and
cause, at least in part, a synchronization of the bulky data by a second connectivity means.

17. An apparatus of claim 11, wherein the apparatus is further caused to:
determine the local information based, at least in part, on an overlapping of one or more augmented reality views associated with the at least one device, the one or more other devices, or a combination thereof.

18. An apparatus of claim 11, wherein the apparatus is further caused to:
determine the local information based, at least in part, on one or more sharing preferences, one or more privacy policies, one or more security policies, or a combination thereof associated with the at least one device, the one or more other devices, or a combination thereof.

19. An apparatus of claim 11, wherein the apparatus is further caused to:
determine the presentation of the local information for the at least one device, the one or more devices, or a combination thereof based, at least in part, on respective position information.

20. An apparatus of claim 11, wherein the at least one augmented reality object aggregate, at least in part, one or more computation closures for processing the local information.

21.-48. (canceled)
